(19) United States
(12) Patent Application Publication
(10) Pub. No.: US 2025/0283392 A1
(43) Pub. Date: Sep. 11, 2025

(54) GEOLOGICAL CARBON SEQUESTRATION AND HYDROGEN PRODUCTION STRUCTURE AND METHOD BASED ON THE SPONTANEOUS REACTION OF WATER-CO2-ACTIVE MINERALS

(71) Applicant: WUHAN UNIVERSITY, Hubei (CN)

(72) Inventors: Xuhai TANG, Hubei (CN); Quansheng LIU, Hubei (CN); Yiwei LIU, Hubei (CN); Lizhi HUANG, Hubei (CN); Yuwen TONG, Hubei (CN)

(73) Assignee: WUHAN UNIVERSITY, Hubei (CN)

(21) Appl. No.: 18/906,158

(22) Filed: Oct. 3, 2024

(30) Foreign Application Priority Data
Mar. 5, 2024 (CN) 202410245682.6

(51) Int. Cl. E21B 41/00

(52) U.S. Cl. CPC E21B 41/0064

(57) ABSTRACT

The present application is related to a geological carbon sequestration and hydrogen production structure and method based on the spontaneous reaction of water, CO₂, and active minerals, belonging to the field of carbon sequestration and hydrogen production technology. The method comprises the following steps: (1) CO₂ collection; (2) selecting a site for carbon sequestration and hydrogen production; (3) constructing a space for carbon sequestration and hydrogen production; (4) CO₂ mineralization sequestration and simultaneous hydrogen production; (5) hydrogen collection. The method permanently mineralizes and sequesters CO₂ while using the water-CO₂-active minerals reaction for simultaneous geological hydrogen production. It not 10 only reduces the economic cost of CO₂ geological sequestration but also opens a new pathway for in-situ geological hydrogen production, achieving green and low-carbon hydrogen energy production. The geological carbon sequestration and hydrogen production structure is designed to have low sequestration costs and enable large-scale simultaneous geological hydrogen production.

### CROSS-REFERENCE TO RELATED APPLICATION

This application claims the priority benefit of China application no. 202410245682.6 filed on Mar. 5, 2024. The entirety of the above-mentioned patent application is hereby incorporated by reference herein and made a part of this specification.

### BACKGROUND OF THE INVENTION

### Technical Field

The invention pertains to the field of carbon sequestration and hydrogen production technology, specifically to a geological carbon sequestration and hydrogen production structure and method based on the spontaneous reaction of water, CO₂, and active minerals.

### Background Art

With the rapid development of modern society, the demand for fossil energy is increasing, leading to a significant rise in greenhouse gas emissions such as carbon dioxide (CO₂) in the atmosphere. This has resulted in worsening global ecological issues such as rising temperatures and climate change. Reducing CO₂ emissions has become an urgent global need. Carbon Capture, Utilization, and Storage (CCUS) technology can separate CO₂ from industrial processes, energy use, or the atmosphere, and either utilize it or reinject it into geological formations for permanent reduction of CO₂. Additionally, CCUS is a crucial supplementary method for transitioning existing energy systems to low-carbon solutions, helping balance economic development with environmental protection.

Geological CO₂ sequestration holds the potential to permanently store up to trillions of tons of CO₂ in specific shallow or deep reservoirs. CO₂ mineralization sequestration technology involves dissolving CO₂ in formation water and reacting it with formation rock minerals to produce carbonate minerals, thus achieving mineralization sequestration. This method is the most permanent and safe mechanism of CO₂ geological sequestration. CO₂ mineralization sequestration features low raw material costs, low energy consumption, spontaneous reactions, and permanent carbon storage with no leakage risk, presenting promising application prospects.

Hydrogen energy offers high energy density, high calorific value, and diverse sources. Currently, hydrogen production is predominantly from fossil fuels, with “gray hydrogen” produced from coal, oil, and natural gas accounting for about 95%. Although this technology is mature, it releases large amounts of CO₂ during hydrogen production, making it less ideal from an environmental perspective. “Blue hydrogen,” produced from natural gas via steam methane reforming or autothermal reforming, and “green hydrogen,” produced using renewable energy, are still in development and are costly.

Traditional industrial hydrogen production methods require reaction vessels, energy input through processes like electrolysis, or catalysts, resulting in higher costs. While traditional deep geological CO₂ mineralization sequestration methods can store CO₂ in deep reservoirs and convert it into carbonate rocks, the methods have not yet integrated the advantages of mineralization sequestration sites for simultaneous geological hydrogen production.

### SUMMARY OF THE INVENTION

In view of the deficiencies of existing technologies, the first aspect of the present invention provides a geological carbon sequestration and hydrogen production structure that offers lower sequestration costs and can simultaneously produce hydrogen compared to traditional industrial methods. This structure includes CO₂ injection channels, H₂ collection channels, geological reaction mineral layers, and sealing structures.

The geological reaction mineral layer includes active minerals that serve both as filling material and reaction substrates. The outer layer of the geological reaction mineral layer is enclosed by a sealing structure, which prevents the diffusion of CO₂ and hydrogen from the interior to the exterior.

The CO₂ injection channel penetrates the sealing structure and extends into the geological reaction mineral layer to inject the CO₂ and water needed for the reaction. Hydrogen gas generated from the reaction escapes from the geological reaction mineral layer due to the density difference with the active minerals and is collected via the H₂ collection channel that also penetrates the sealing structure.

Active minerals with carbon sequestration and hydrogen production capabilities include metal oxides that react with CO₂ to form carbonates and ferrous ions that react with water to generate hydrogen.

Preferably, the active minerals include at least one of the following: iron-rich minerals, nickel-rich minerals, pyroxene, olivine, magnetite, chalcopyrite, or basalt.

Utilizing active minerals with ferrous ions from basalt, chalcopyrite slag, and other sources, such as iron-rich minerals, nickel-rich minerals, pyroxene, olivine, magnetite, and chalcopyrite, can react spontaneously with water and CO₂ to produce hydrogen without additional energy input or catalysts.

Preferably, depending on the depth of the carbon sequestration and hydrogen production layer, the geological structure is divided into shallow and deep geological carbon sequestration and hydrogen production structures.

Further preferably, in the shallow geological carbon sequestration and hydrogen production structure, the sealing structure is an artificial sealing layer; the geological reaction mineral layer is an artificial storage layer, which may include abandoned open-pit mines or abandoned underground mining tunnels.

Further preferably, in the deep geological carbon sequestration and hydrogen production structure, the escaped hydrogen accumulates in a hydrogen-rich area formed by the sealing structure, and is recovered via the H₂ collection channel. The sealing structure is a natural cap rock, and the geological reaction mineral layer is a natural mineralization storage layer, including natural saline aquifers, depleted oil and gas reservoirs, or basalt formations rich in natural fractures.

In the second aspect of the present invention, a large-scale carbon sequestration and hydrogen production method that is easy to control is provided, using the geological carbon sequestration and hydrogen production structure described in the first aspect. This method is based on the spontaneous reaction of water, CO₂, and active minerals and includes the following steps:

### (1) CO₂ Collection

Collecting CO₂ produced from industrial activities;

### (2) Selecting Carbon Sequestration and Hydrogen Production Sites

Identifying suitable regions for geological carbon sequestration and hydrogen production through geological surveys, designating these areas as geological reaction mineral layers. Based on the depth of the carbon sequestration and hydrogen production layers, classify them into shallow and deep geological carbon sequestration and hydrogen production sites.

### (3) Constructing the Carbon Sequestration and Hydrogen Production Space

Using a sealing structure to enclose the geological reaction mineral layer to store CO₂ and prevent hydrogen leakage. Connecting CO₂ injection channels and H₂ collection channels through the sealing structure to access the geological reaction mineral layer, creating a space for effective carbon sequestration, hydrogen production, and subsequent product recovery. Injecting CO₂ and water into the geological reaction mineral layer through the CO₂ injection channels;

### (4) CO₂ Mineralization Sequestration and Simultaneous Gydrogen Production

Performing CO₂ mineralization sequestration and simultaneous hydrogen production using the spontaneous reaction between CO₂, water, and active minerals based on the CO₂-water-active mineral reaction.

### (5) Hydrogen Collection

After CO₂ mineralization and hydrogen accumulation is complete, collecting hydrogen stored in the pore spaces of the geological reaction mineral layer and the upper space of the reservoir using the H₂ collection channel, along with other by-products.

Preferably, in step (2), shallow geological carbon sequestration and hydrogen production sites are artificial storage layers, such as abandoned open-pit mines or abandoned underground mining tunnels. Deep geological carbon sequestration and hydrogen production sites are natural mineralization storage layers, including natural saline aquifers, depleted oil and gas reservoirs, or basalt formations rich in natural fractures.

Further preferably, when shallow geological carbon sequestration and hydrogen production sites are used in step (2), the construction process of the carbon sequestration and hydrogen production space in step (3) includes designing and laying an artificial sealing layer, grinding active minerals to fill the artificial storage layer, and injecting CO₂ and water.

The design of the artificial sealing layer materials can be based on natural cap rock layers. For example, dense shale and diabase, found in natural hydrogen reservoirs in the Pyrenees in Spain and Bourakébougou in Mali, can be used as references. Grinding abundant natural active minerals such as basalt and chalcopyrite slag, and filling these into the shallow storage layer. These active minerals serve as both the filling material for open-pit mines and underground tunnels and the reaction substrates for carbon sequestration and hydrogen production. Minerals with carbon sequestration and hydrogen production capabilities include iron-rich minerals, nickel-rich minerals, pyroxene, olivine, magnetite, and chalcopyrite. Basalt, containing about 15% by mass of ferrous ions, is among these. This approach also addresses the issue of insufficient filling materials such as gangue. Finally, injecting a CO₂ and water mixture into the bottom of the geological storage site continuously using high-pressure injection equipment to react with the rock.

Further preferred embodiments of the invention are as follows:

1. Deep geological carbon sequestration and hydrogen production sites: When shallow geological carbon sequestration and hydrogen production sites are used in step (2), step (3) involves using natural mineralization storage layers and natural cap rock layers in deep reservoirs. CO₂ and water are injected using drilling or abandoned oil and gas wells.

2. Hydrogen collection in shallow sites: When shallow geological carbon sequestration and hydrogen production sites are used in step (2), step (5) involves collecting hydrogen and by-products using pipelines as H₂ collection channels.

3. Hydrogen collection in deep sites: When deep geological carbon sequestration and hydrogen production sites are used in step (2), step (5) involves identifying hydrogen accumulation areas and collecting hydrogen using wellbores as H₂ collection channels.

Based on the above technical solutions, the inventive concept of the present invention is to utilize the spontaneous reaction of water-CO₂-active minerals for both CO₂ mineralization sequestration and simultaneous hydrogen production. CO₂ dissolves in water to form carbonic acid. Active minerals containing ferrous ions, such as basalt, chalcopyrite, pyroxene, magnetite, and olivine, interact with carbonic acid, leading to the dissolution of ferrous-ion minerals such as iron-bearing minerals, nickel-bearing minerals, pyroxene, olivine, magnetite, and chalcopyrite, which release ferrous ions. These ferrous ions are adsorbed on the rock surface, serving as electron donors for water reduction and hydrogen production, without requiring additional energy input or catalysts. The reactions between rocks, CO₂, and water release magnesium, calcium, potassium, phosphorus, and other nutrients, with by-products that can be used as soil improvers to enhance crop yields.

The invention aims to use abandoned open-pit mines, abandoned underground mining tunnels, and natural geological spaces in deep reservoirs in combination with the water-CO₂-active mineral spontaneous reaction, which does not require additional energy input or catalysts, to significantly reduce hydrogen production costs. In shallow areas such as abandoned open-pit mines and underground mining tunnels, tailings and basalt can be used for carbon sequestration and hydrogen production, addressing the issue of insufficient backfill and filling materials. Shallow areas are accessible for construction activities such as rock filling, sealing layer installation, injection channel installation, collection channel installation, and calcium carbonate by-product recovery, making them easier to control and less demanding in terms of geological conditions. Deep natural geological spaces, such as natural saline aquifers and depleted oil and gas reservoirs, provide larger spaces for larger-scale carbon sequestration and hydrogen production.

Compared to existing technologies, the present invention offers the following advantages and beneficial effects:

1. The invention provides a structure designed with low geological requirements and ease of control, featuring low sequestration costs and the capability for large-scale simultaneous geological hydrogen production.

2. The method allows for permanent CO₂ mineralization sequestration while simultaneously producing hydrogen through spontaneous reactions of water-CO₂-active minerals.

This approach not only reduces the economic costs of CO₂ geological sequestration but also opens new pathways for in-situ geological hydrogen production, achieving green and low-carbon hydrogen production.

### BRIEF DESCRIPTION OF THE DRAWINGS

FIG. 1: Schematic diagram of carbon sequestration and hydrogen production in an abandoned open-pit mine.

FIG. 2: Schematic diagram of carbon sequestration and hydrogen production in an underground tunnel.

FIG. 3: Schematic diagram of the structure for carbon sequestration and hydrogen production in deep reservoirs.

FIG. 4: Process flow diagram of carbon sequestration and hydrogen production.

FIG. 5: Hydrogen production curve of basalt over time obtained from laboratory experiments.

FIG. 6: Hydrogen production curve of chalcopyrite and pyrite over time obtained from laboratory experiments.

In the figures:
Reference signs: 1—CO₂ injection channel; 2—H₂ collection channel; 3—Artificial confining layer; 4—Artificial sealing layer; 5—Hydrogen-rich area; 6—Natural sealing cap layer; 7—Natural mineralization sequestration layer.

### DETAILED DESCRIPTION OF THE EMBODIMENTS

The following embodiments further illustrate the present invention, but do not limit the scope of the invention to the described embodiments. Experimental methods without specific conditions in the following examples are selected according to conventional methods and conditions or according to the product instructions.

### Example 1

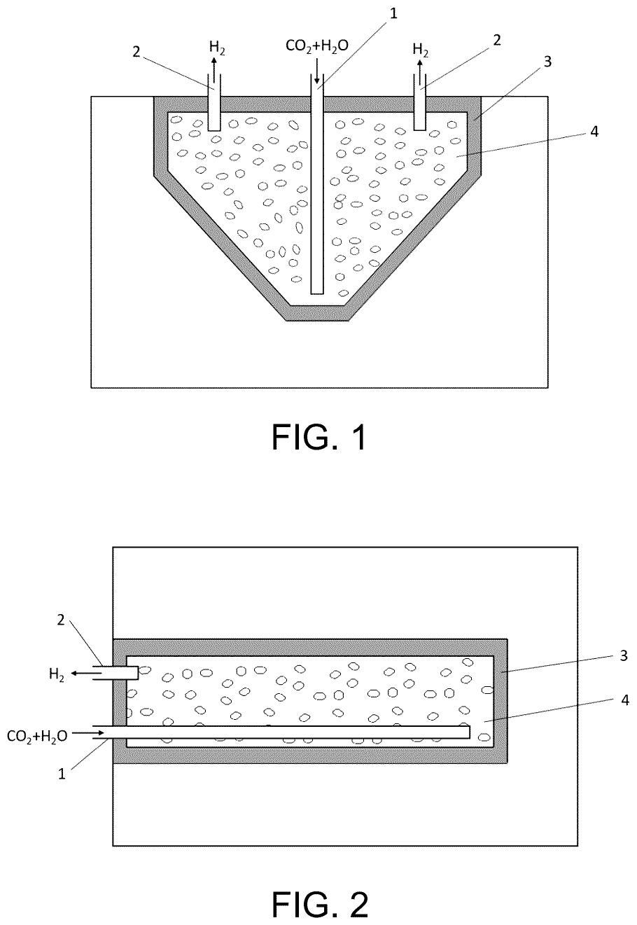

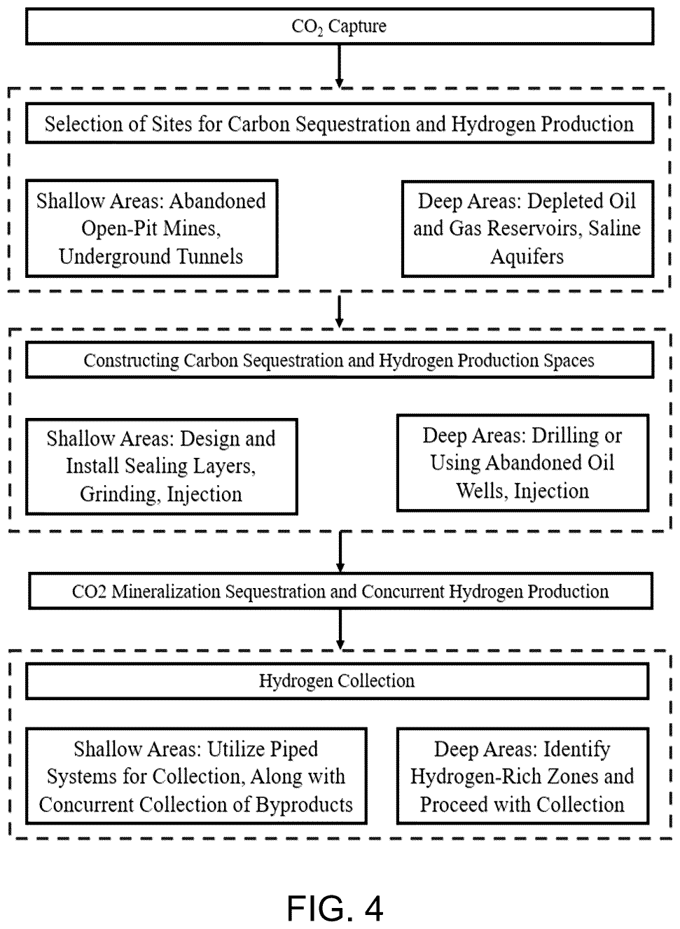

This embodiment provides a method for geological carbon sequestration and hydrogen production, utilizing the geological structure of an abandoned open-pit mine as shown in FIG. 1. The method is based on the spontaneous reaction of water, CO₂, and reactive minerals, and the process is illustrated in FIG. 4. The steps are as follows:

### (1) CO₂ Collection

Collecting CO₂ produced from industrial activities;

### (2) Selection of Carbon Sequestration and Hydrogen Production Site

Using the abandoned open-pit mine as the artificial sealing layer 4;

### (3) Construction of Carbon Sequestration and Hydrogen Production Space

The artificial sealing layer 4 is filled with ground basalt, pyrrhotite slag, and other reactive rocks, providing a site for the spontaneous reaction of water, CO₂, and reactive minerals for carbon sequestration and hydrogen production. The artificial sealing layer 4 is enclosed by an artificial confining layer 3, isolating it from the surrounding environment, sequestering CO₂, and preventing hydrogen leakage. The CO₂ injection channel 1 extends from the surface to the bottom of the reactive rocks in the artificial sealing layer 4, ensuring sufficient reaction between CO₂, water, and reactive rocks. The H₂ collection channels 2 are located on both sides of the CO₂ injection channel 1, connecting to the top of the artificial sealing layer 4 for easy hydrogen collection. Injecting CO₂ and water;

### (4) CO₂ Mineralization and Simultaneous Hydrogen Production

CO₂, water, and reactive minerals spontaneously react to achieve CO₂ mineralization and simultaneous hydrogen production;

### (5) Hydrogen Collection

After CO₂ mineralization and hydrogen accumulation, hydrogen is stored in the rock pores and the upper space of the geological reaction layer. Hydrogen and other by-products are collected using pipelines as H₂ collection channels.

### Example 2

This embodiment provides a method for geological carbon sequestration and hydrogen production, utilizing the geological structure of an underground tunnel as shown in FIG. 2. The method is based on the spontaneous reaction of water, CO₂, and reactive minerals. The steps are as follows:

### (1) CO₂ Collection

Collecting CO₂ produced from industrial activities;

### (2) Selection of Carbon Sequestration and Hydrogen Production Site

Using the underground tunnel as the artificial sealing layer 4;

### (3) Construction of Carbon Sequestration and Hydrogen Production Space

The artificial sealing layer 4 is filled with ground basalt, pyrrhotite slag, and other reactive rocks, providing a site for the spontaneous reaction of water, CO₂, and reactive minerals for carbon sequestration and hydrogen production. The artificial sealing layer 4 is enclosed by an artificial confining layer 3, isolating it from the surrounding environment, sequestering CO₂, and preventing hydrogen leakage. The CO₂ injection channel 1 extends from the entrance of the underground tunnel to the bottom of the reactive rocks in the artificial sealing layer 4, ensuring sufficient reaction between CO₂, water, and reactive rocks. The H₂ collection channels 2 are located above the CO₂ injection channel 1, connecting to the top of the reactive rocks in the artificial sealing layer 4 for easy hydrogen collection. Inject CO₂ and water;

### (4) CO₂ Mineralization and Simultaneous Hydrogen Production

CO₂, water, and reactive minerals spontaneously react to achieve CO₂ mineralization and simultaneous hydrogen production;

### (5) Hydrogen Collection

After the carbon dioxide mineralization and hydrogen accumulation processes are completed, hydrogen is stored within the rock pores and the upper space of the geological reaction layer. Hydrogen and other by-products are collected by laying pipelines as H₂ collection channels.

### Example 3

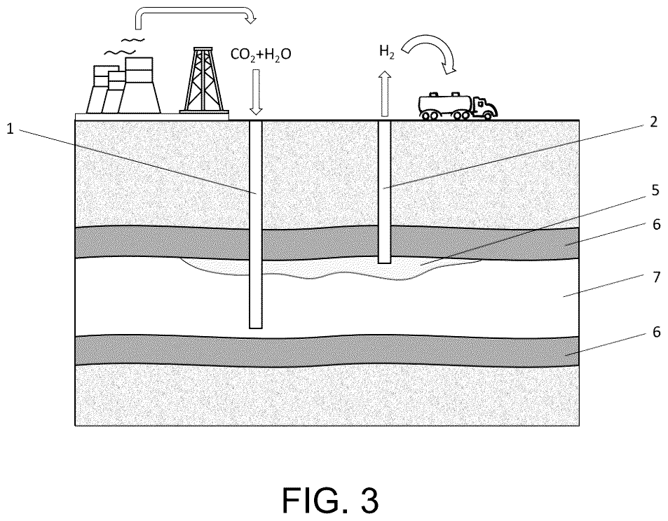

This embodiment provides a method for geological carbon sequestration and hydrogen production, utilizing the deep reservoir geological structure for carbon sequestration and hydrogen production, as shown in FIG. 3. The method is based on the spontaneous reaction of water, CO₂, and reactive minerals. The steps are as follows:

### (1) CO₂ Collection

Collecting CO₂ produced from industrial activities;

### (2) Selection of Carbon Sequestration and Hydrogen Production Site

Using a natural saline aquifer, depleted oil and gas reservoir, or a basalt formation rich in natural fractures as the natural mineralization sequestration layer 7;

### (3) Construction of Carbon Sequestration and Hydrogen Production Space

The natural mineralization sequestration layer 7 contains reactive minerals for sequestering CO₂ and serves as the site for the spontaneous reaction of water, CO₂, and reactive minerals for carbon sequestration and hydrogen production. The natural sealing cap layer 6 prevents CO₂ and hydrogen from leaking into other areas under pressure. The CO₂ injection channel 1, formed by drilling a well, reaches the bottom of the natural mineralization sequestration layer 7 to inject CO₂ and water into the carbon sequestration and hydrogen production area. The H₂ collection channel 2, also formed by drilling, is located at the top of the carbon sequestration and hydrogen production area for collecting hydrogen. Due to the lower density of hydrogen compared to most fluids, a hydrogen-rich area 5 will form above the natural mineralization sequestration layer 7. Connecting the H₂ collection channel 2 to this area facilitates hydrogen collection;

### (4) CO₂ Mineralization and Simultaneous Hydrogen Production

CO₂, water, and reactive minerals undergo a spontaneous reaction based on the CO₂-water-reactive mineral system, leading to CO₂ mineralization and simultaneous hydrogen production;

### (5) Hydrogen Collection

After CO₂ mineralization and hydrogen accumulation, hydrogen is stored within the rock pores and the upper space of the geological reaction layer. The hydrogen-rich area is identified, and hydrogen is collected using the drilled well;

### Example 4

This embodiment studies the effectiveness of the method for CO₂ mineralization and simultaneous hydrogen production under simulated conditions. The working principle of the present invention, which involves the spontaneous reaction of water, CO₂, and reactive minerals to produce hydrogen, can be represented by the following chemical equations:

CO₂+MgO/CaO=MgCO₃/CaCO₃ (1)

2FeO+H₂O=H₂+Fe₂O₃ (2)

Carbon dioxide reacts with calcium and magnesium ions in rocks, resulting in mineralization and carbon sequestration (Reaction 1). Additionally, iron-rich rocks undergo interactions with water and CO₂, producing significant amounts of hydrogen (Reaction 2). When carbon dioxide dissolves in water, it forms carbonic acid. The acidity of carbonic acid causes minerals containing ferrous ions, such as pyroxene, magnetite, and olivine, to dissolve and release ferrous ions. These released ferrous ions are adsorbed onto the surface of basalt, where they act as electron donors, reducing water and generating hydrogen.

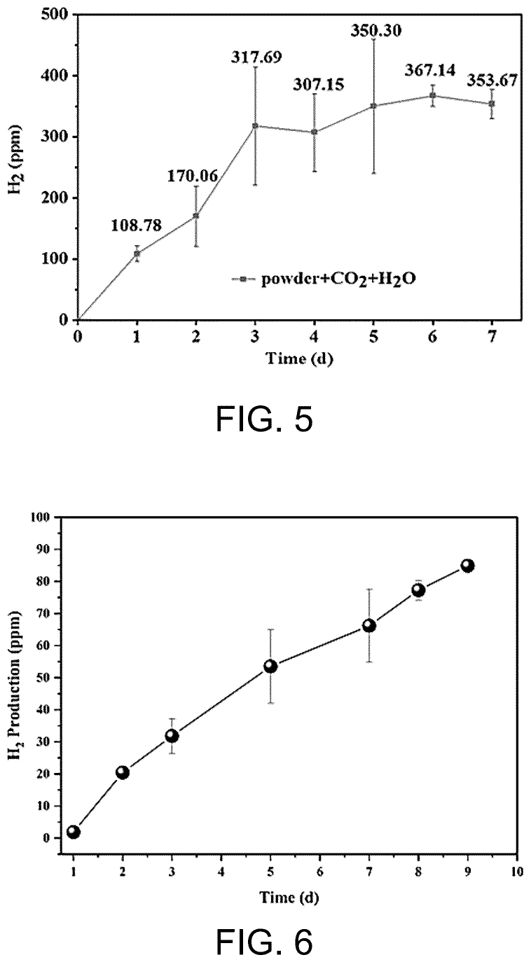

The effectiveness of spontaneous CO₂-water-basalt reactions for CO₂ mineralization and simultaneous hydrogen production was studied through laboratory experiments. In the experiment, 2 grams of rock samples were first crushed and then placed in a ball mill jar, which was evacuated and ball-milled under anoxic conditions for 20 hours. The rock powder was then extracted with 100 mL of water in an anoxic glovebox and transferred to small glass vials (5 mL each). Dry ice (CO₂) was added to the vials, which were then sealed and allowed to react for a set period. Hydrogen production was measured using gas chromatography. The experiment produced a time-dependent curve of hydrogen production from basalt, as shown in FIG. 5. Hydrogen production increased steadily for the first three days, stabilizing thereafter. The results also indicated that the water-CO₂-basalt reaction produces hydrogen, whereas the water-basalt reaction does not produce hydrogen in the absence of CO₂. This suggests that the coexistence of groundwater and basalt over millions of years has reached a stable state, and hydrogen production occurs only when additional CO₂ is introduced, as in the sequestration process.

The above describes the preferred specific embodiments of the present invention in detail. It should be understood that those skilled in the art can make numerous modifications and variations based on the concept of the invention without creative efforts. Therefore, any technical solutions derived from logical analysis, reasoning, or limited experiments based on the concept of the invention by those skilled in the art should fall within the protection scope defined by the claims.

What is claimed is:

1. A geological carbon sequestration and hydrogen production structure, characterized by including comprising
a CO₂ injection channel, an H₂ collection channel, a geological reaction mineral layer, and a sealing structure;
wherein the geological reaction mineral layer comprises active minerals that serve as both filling material and reaction substrate, an outer layer of the geological reaction mineral layer is enclosed by the sealing structure,
wherein the sealing structure prevents the diffusion of CO₂ and hydrogen from inside of the geological reaction mineral layer to outside of the geological reaction mineral layer,
wherein the CO₂ injection channel penetrates the sealing structure and extends into the geological reaction mineral layer for injecting CO₂ and water for a reaction, hydrogen produced by the reaction escapes from the geological reaction mineral layer due to a density difference with the active minerals and is collected through the H₂ collection channel that penetrates the sealing structure,
wherein the active minerals have a capability of carbon sequestration and hydrogen production, and comprises metal oxides that react with CO₂ to form carbonates and ferrous ions that react with water to produce hydrogen.

2. The geological carbon sequestration and hydrogen production structure according to claim 1, wherein the active minerals include at least one of siderite, nickeliferous siderite, pyroxene, olivine, magnetite, pyrrhotite, and basalt.

3. The geological carbon sequestration and hydrogen production structure according to claim 1, wherein based on a depth of a carbon sequestration and hydrogen production strata, the geological carbon sequestration and hydrogen production structure is divided into shallow geological carbon sequestration and hydrogen production structures, and deep geological carbon sequestration and hydrogen production structures.

4. The geological carbon sequestration and hydrogen production structure according to claim 3, wherein in the shallow geological carbon sequestration and hydrogen production structure, the sealing structure is an artificial confining layer; the geological reaction mineral layer is an artificial sealing layer, which includes one of an abandoned open-pit mine or an abandoned underground mining tunnel.

5. The geological carbon sequestration and hydrogen production structure according to claim 3, wherein in the deep geological carbon sequestration and hydrogen production structure, H₂ accumulates to form a hydrogen-rich area under a barrier of the sealing structure after escaping from the geological reaction mineral layer, and is recovered through the H₂ collection channel; the sealing structure is a natural sealing cap layer; the geological reaction mineral layer is a natural mineralization sequestration layer, which includes one of a natural saline aquifer, a depleted oil and gas reservoir, or a basalt formation rich in natural fractures.

6. A geological carbon sequestration and hydrogen production method employing the geological carbon sequestration and hydrogen production structure of claim 1 for geological carbon sequestration and hydrogen production, comprising the following steps:
(1) CO₂ collection:
collecting CO₂ generated from industrial activities;
(2) selection of carbon sequestration and hydrogen production site:
selecting suitable areas for geological carbon sequestration and hydrogen production through geological surveys and other means, designating the suitable areas as geological reaction mineral layers, dividing the geological reaction mineral layers into shallow geological carbon sequestration and hydrogen production site and deep geological carbon sequestration and hydrogen production site based on the depth of the carbon sequestration and hydrogen production strata;
(3) construction of carbon sequestration and hydrogen production space:
using sealing structures to enclose the geological reaction mineral layer for sequestering CO₂ and preventing hydrogen leakage, connecting the CO₂ injection channel and the H₂ collection channel through the sealing structure into the geological reaction mineral layer, creating a space that facilitates carbon sequestration and hydrogen production as well as a subsequent collection of products, injecting CO₂ and water into the geological reaction mineral layer through the CO₂ injection channel;
(4) CO₂ mineralization sequestration and simultaneous hydrogen production:
conducting CO₂ mineralization sequestration and simultaneous hydrogen production through a spontaneous reaction of CO₂, water, and active minerals based on a CO₂-water-active mineral reaction;
(5) hydrogen collection:
after completion of CO₂ mineralization and hydrogen accumulation, storing hydrogen in rock pores and an upper space of a reservoir within the geological reaction mineral layer, and collecting hydrogen and other byproducts through the H₂ collection channel.

7. The method according to claim 6, wherein in the step (2), the shallow geological carbon sequestration and hydrogen production site are artificial sequestration layers, comprising abandoned open-pit mines and abandoned underground mining tunnels; the deep geological carbon sequestration and hydrogen production site are natural mineralization sequestration layers, comprising natural saline aquifers, depleted oil and gas reservoirs, and basalt formations rich in natural fractures.

8. The method according to claim 7, wherein when the shallow geological carbon sequestration and hydrogen production site is used in the step (2), a construction process of the carbon sequestration and hydrogen production space in the step (3) comprises designing and laying artificial sealing layers, grinding the active minerals and filling the active materials into the artificial sequestration layers, and injecting CO₂ and water, and
wherein when the deep geological carbon sequestration and hydrogen production site is used in the step (2), a deep reservoir in the step (3) comprises a natural mineralization sequestration layer and a natural sealing cap layer, with CO₂ and water injected using drilling or abandoned oil and gas wells.

9. The method according to claim 7, wherein when the shallow geological carbon sequestration and hydrogen production site is used in the step (2), in the step (5), hydrogen and byproducts are collected using pipelines as the H₂ collection channel; and when the deep geological carbon sequestration and hydrogen production site is used in the step (2), in the step (5), hydrogen is collected by identifying hydrogen-rich areas and using wellbores as the H₂ collection channel.
